(19) United States
(12) Patent Application Publication
(10) Pub. No.: US 2009/0206592 A1
(43) Pub. Date: Aug. 20, 2009

(54) CLIPBOARD

(76) Inventor: Stephen Summerhayes, Norwich (GB)

Correspondence Address: Thomas M. Galgano, 20 W. Park Avenue, Suite 204, Long Beach, NY, 11561, US

(21) Appl. No.: 12/372,289

(22) Filed: Feb. 17, 2009

(30) Foreign Application Priority Data
Feb. 15, 2008 (GB) GB08 02798.9

(51) Int. Cl. B43L 5/02

(52) U.S. Cl. 281/45

(57) ABSTRACT

A pad is disclosed to assist a user to carry a number of small articles such as a mobile telephone, calculator, personal digital assistant etc. The pad, typically about the size of A4 paper, has a flat surface having plurality of magnets associated therewith. The magnets can be located beneath the surface of the pad protected by a layer of plastics material or can be flush with the surface. Typically, a magnet is disc-shaped but can also be in the form of a strip for particular uses. A bulldog clip or the like can be included in order to retain papers or forms on the pad. If necessary, a magnet or magnetizable element can be affixed to an article to be carried to provide the article with engagement with the magnets.

### FIELD OF THE INVENTION

The present invention relates to a device to enable small articles such as pens, calculators, measuring tapes etc to be earned in an easily accessible fashion. In particular, the device has a flat surface allowing the articles to be removably fixed to the device.

### BACKGROUND OF THE INVENTION

The device disclosed herein is intended primarily although not exclusively, to assist a user who has need to have a number of small items readily to hand, especially on moving from place to place. For example, a building surveyor when carrying out measurements on a building needs to have available articles such as pens, calculators, cameras, keys and measuring devices etc.

Typically, such articles are carried around in jacket pockets, bags or small cases and as such can easily become, albeit temporarily, mislaid. Apart from the increased time this occasions being required to carry out a particular task, the need to have to repeatedly find an object is tiresome and can also lead to the appearance of a lack of professionalism.

Clipboards can assist in overcoming this problem, but for the most part, the only means of attaching objects thereto is by means of a bulldog clip provided and also through specially designed clips for pens.

A number of prior art documents have attempted to solve the problem. U.S. Pat. No. 5,413,382 discloses a clipboard in which magnets are included within a bulldog clip at one end of the board. The magnets hold items such as paperclips or other small items, safely against the board.

U.S. Pat. No. 6,305,656 discloses a device to be attached to the dashboard of an automobile, the device having a magnetic base to hold an article in position. A support assembly can be included if the article is particularly heavy or unwieldy.

It is therefore an object of the present invention to provide a portable transport device which enables a user to carry a number of items in a manner which allows ready access to said items. It is a further object of the invention to provide a method of transporting items by hand.

### SUMMARY OF THE INVENTION

According to a first aspect of the invention there is provided a hand-held portable device for transporting one or more articles the device comprising a planar surface to receive items to be transported; a plurality of magnets, attached to or located within said planar surface to hold said items against the device. The device therefore enables a number of articles to be carried and to be easily accessible for the user.

Advantageously, the planar surface comprises a plastics material allowing it to be easily cleanable and waterproof.

Optionally, each magnet is located underneath the planar surface to protect the magnets from water and other harmful materials. Further optionally, the or each magnet is set into a plastics layer to give additional protection and corrosion resistance.

Advantageously each magnet is set at a sufficient spaced apart distance from a neighbouring magnet to enable articles to be carried without interference between the articles. Further conveniently the magnet is located at each corner of a device to provide sufficient spacing. Optionally, the magnets are of differing sizes, to enable articles of different sizes to be carried without unduly increasing the weight of a device.

Preferably, one or more of the magnets is a strip magnet which hinders rotation of an article held on the device.

Optionally, the device includes one or more bulldog clips, the or each clip enabling the flexible articles such as paper to be held in position.

According to a second aspect of the invention, there is provided a method of carrying by hand one or more articles, the method comprising the steps of selecting a transport device as described herein; placing an article to be transported into close spatial relationship with a magnet of the device and releasing die article, allowing said article to be held against the device by magnetic attraction.

Optionally, an attraction element formed of a magnetic or magnetisable metal is affixed to an article prior to the article being brought into engagement with the device. The device can therefore be used to hold articles which are insufficiently attracted to the device by magnetism alone. Further optionally, the element is disc-shaped to minimise loss of magnetic attraction and keep the bulk and weight of the device to a minimum. Alternatively, the element is strip shaped to hinder rotation of an article.

Conveniently, the element includes an adhesive to enable the element to adhere to an article.

### BRIEF DESCRIPTION OF THE DRAWINGS

The invention will now be described with reference to the accompanying drawings which show by way of example only, two embodiments of a pad. In the drawings;

FIG. 1 illustrates a front view of a first embodiment of a pad;

FIG. 2 illustrates a section through the pad of FIG. 1;

FIG. 3 illustrates a fixture element; and

FIG. 4 illustrates a front view of a second embodiment of a pad.

### DETAILED DESCRIPTION OF THE INVENTION

The pad as described herein is intended primarily to facilitate the carriage of, organise and allow access to relatively small articles such as a mobile telephone, calculator, personal digital assistant (PDA) etc. Such items are normally carried about a person in one or more jacket pockets or in a carrier. As such, items can very easily become temporarily misplaced and time is lost looking for them. Moreover, searching through pockets, whilst carrying out a task can look unprofessional and also lead to the damage of other articles in the pocket if they are pulled out accidentally.

The pad has the items releasably attached to a planar surface, so that an item can be selected easily. In its principal embodiment, the pad resembles a conventional clipboard in that the pad includes a flat board, approximately having the dimensions of an A4 sheet of paper. Included in the pad are a number of magnets distributed about the board area which serve to attract items to the pad's planar surface. If required, due to the non-magnetic character of a particular item, a metal element can be affixed to an item enabling the item to be held onto the pad.

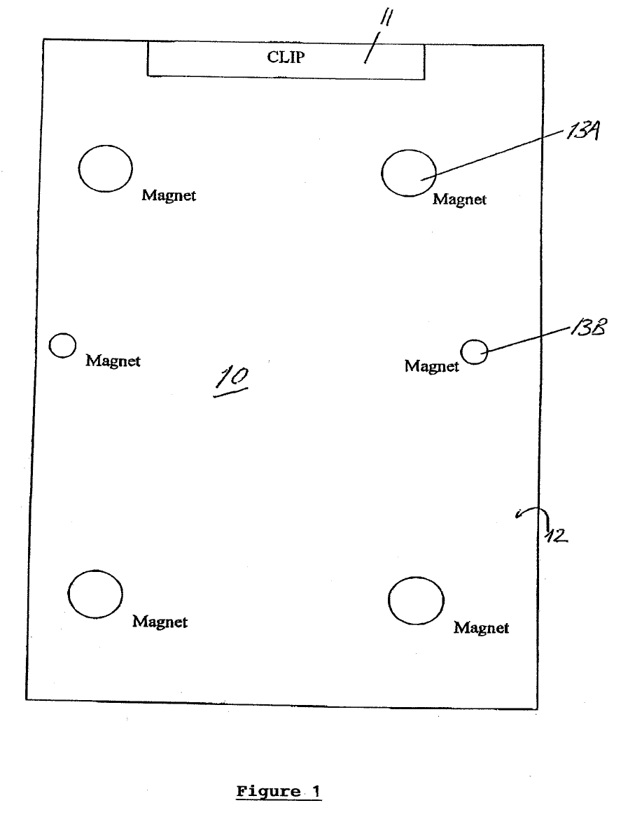

Referring now to FIG. 1 a top view of a pad 10 can be seen. It should be stressed that the magnets shown may or may not be directly visible to a user. In some embodiments the magnets lie beneath an opaque layer of plastics or other material. In the latter case the location of a magnet can be indicated by a suitable sign printed on or otherwise incorporated into the material.

The pad 10 shown is approximately the size of an A4 sheet of paper enabling it to be easily carried. At a narrow end of the pad 10, a retaining clip 11 is provided to allow papers or other items to be held in place. It should be noted that the pad 10 is intended primarily for use without a clip 11 and that the prime function of the pad 10 is to carry articles exemplified above through the use of magnetic force. The clip 11 may be dispensed with by the user if they so desire to provide more space on the pad 10.

At spaced locations about the planar surface 12 of die pad 10 are magnets 13A, 13B. The magnets 13A, 13B, are standard, readily available items which are suitably shaped to fit into the flat form of the pad 10. As such a disc-shaped magnet is particularly suitable, being readily obtainable and sufficiently flat not to unduly increase the thickness of the pad 10.

The magnets 13A, are generally bigger than the magnets 13B and can therefore be employed to retain larger items.

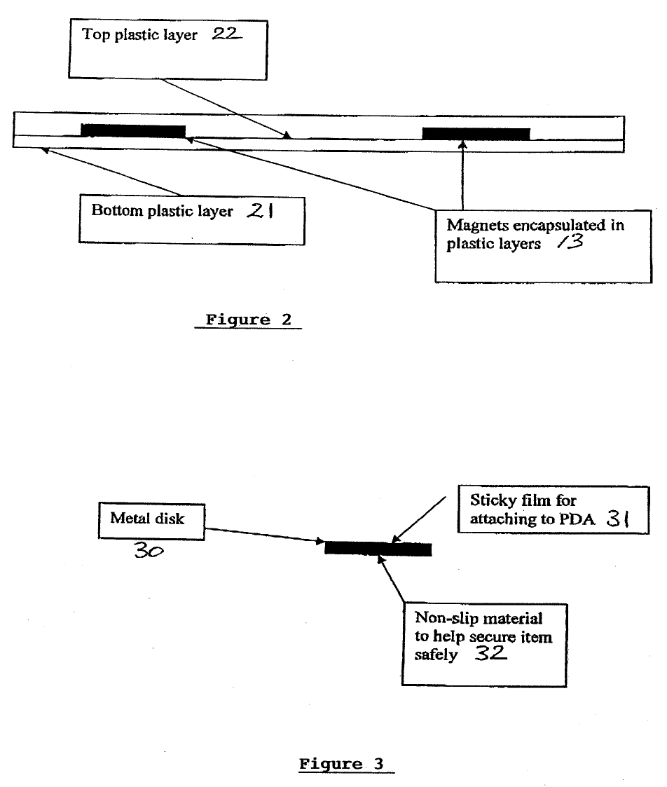

Turning to FIG. 2, which illustrates a view through the side of a pad 10. The pad 10 has a base layer 21 formed of a plastics material. Magnets 13A rest on the base layer 21 and can be fixed to said base layer 21 by means of an adhesive. A second upper layer 22, also of a plastics material acts to protect the magnets 13A from weathering, in particular from water.

The upper layer 22 can be in the form of a cover, overlaid over the base layer 21, but not fixed thereto at each point. For example the cover can be fixed about its outside edge to the base layer 21, effectively sealing in the magnets 13.

In a further embodiment, not illustrated, the upper layer 22 is formed onto the base layer 21, about the magnets 13. One way of so forming this layer is by addition of a liquid polymeric material or a monomer into a mould, over the base layer 21. By setting the polymer or by the use of a suitable polymerisation method well known in the art, the polymer of the upper layer 22 is then formed in situ and attached to the base layer 21.

In a further embodiment, also not illustrated and with particular relevance to the former embodiment of the cover 22 fixed to the base layer 21 about its edge indicated above, this covering upper layer 22 is replaceably removable enabling magnets 13 to be moved to a different position on the pad 10.

Where an item to be carried is not magnetic then a disc 30 as shown in FIG. 3 can be used. The disc 30 is formed of a metal which is magnetic or capable of being magnetised and which therefore is attracted to a magnet 13. The disc 30 further has an adhesive spread on one or other of its surfaces 31, enabling the disc 30 to be attached to an item. Once so attached the item is held to the pad 10 via attraction between the disc 30 and a magnet 13. In order to further ensure that the disc 30 does not slip along the surface 12 of the pad 10, the obverse surface 32 of the disc is made non-slip either through profiling or coating with a non-slip material.

In use therefore, the pad 10 having a number of magnets 13 incorporated therein, is positioned by a user such that the planar surface 12 is accessible to enable items to be placed thereon and releasably attached thereto. An item to be attached thereto is brought into close spaced relationship to a magnet 13. Once the user feels that the item is attracted to the magnet 13, the item is released and is then held in position by said magnet 13. The item is then ready to be carried, attached to the pad 10.

When required, the item can be relatively easily removed from the pad 10, through the application of sufficient force to remove the item from the magnetic field.

Where the item is not magnetic or magnetisable, then a metal disc 30 can be affixed to said item. The disc 30 is affixed to the item by means of an adhesive on one side of the disc 30. The item is then placed onto the pad 10, such that the disc 30 engages magnetically one of the magnets 13, holding the item in position.

It will of course be understood that the invention is not limited to the specific details described herein, which are given by way of example only, and that various modifications and alterations are possible within the scope of the invention.

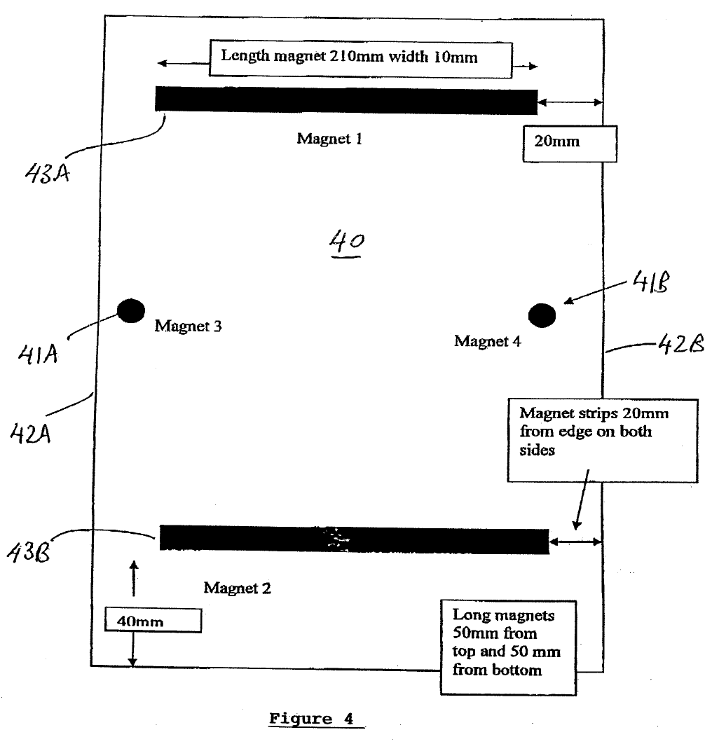

FIG. 4 illustrates a second embodiment of a pad 40. The pad 40 is larger than the pad 10 illustrated in FIG. 1 having a width of 250 mm and a length of 340 mm. In common with the pad 10, two circular magnets 41A, 41B are provided. The magnets 41A, 41B are located approximately 10 mm from the respective edges 42A, 42B of the pad 40 and midway the length although, this location can be varied to suit the intended use.

The pad 40 has two further, strip magnets 43A, 43B, each of dimensions 210 mm by 10 mm and located approximately 50 mm from a short edge of the pad 40. The strip magnets 43A, 43B reduce any tendency of items such as PDAs, telephones to rotate whilst attached to the pad 40. Any magnetic or magnetisable element fixed to the back of an article to assist in attachment to the pad 40 can also be elongate in shape.

1-16. (canceled)

17. A hand-held portable device for transporting one or more articles, the device comprising a planar surface to receive items to be transported; a plurality of magnets, attached to or associated with said planar surface to hold said items against the device.

18. A device according to claim 17, wherein the planar surface comprises a plastics material allowing the surface to be easily cleanable and waterproof.

19. A device according to claim 17, wherein a magnet is located underneath the planar surface to protect the magnets from water and other harmful materials.

20. A device according to claim 18, wherein each magnet is set into a plastics layer.

21. A device according to claim 17, wherein each magnet is set at a sufficient spaced apart distance from a neighboring magnet to enable a first article to be carried without interference from a second article.

22. A device according to claim 21, wherein a magnet is located at each corner of a device.

23. A device according to claim 17, having magnets of at least two different sizes.

24. A device according to claim 17, wherein one or more of the magnets is a strip magnet which hinders rotation of an article held on the device.

25. A device according to claim 17, wherein the device includes one or more bulldog clips.

26. A device according to claim 17, comprising a base layer, each magnet being adhered to the base layer, and a second layer overlaid over the base layer and sandwiching the magnets therebetween.

27. A method of carrying by hand one or more articles, the method comprising the steps of selecting a transport device as described in Claim 17, placing an article to be transported into close spatial relationship with a magnet of the device and releasing the article, allowing said article to be held against the device by magnetic attraction.

28. A method according to claim 27, wherein an attraction element formed of a magnetic or magnetizable metal is affixed to an article prior to the article being brought into engagement with the device.

29. A method according to claim 28, wherein an element is disc-shaped.

30. A method according to claim 28, wherein an element is strip shaped.

31. A method according to claim 28, wherein the element includes an adhesive to enable the element to adhere to an article.
